(19) United States
(12) Patent Application Publication
(10) Pub. No.: US 2026/0006708 A1
(43) Pub. Date: Jan. 1, 2026

(54) PLASMA GENERATION TECHNIQUES FOR ENHANCED PLASMA COHERENCE AND LONGEVITY

(71) Applicant: Champion Aerospace LLC, Liberty, SC (US)

(72) Inventor: Artur P. Suckewer, Franklin Park, NJ (US)

(21) Appl. No.: 19/257,452

(22) Filed: Jul. 1, 2025

Related U.S. Application Data
(60) Provisional application No. 63/666,661, filed on Jul. 1, 2024.

(51) Int. Cl. H05H 1/24

(52) U.S. Cl. CPC H05H 1/24

(57) ABSTRACT

The present disclosure provides plasma generation techniques that may be implemented to maintain plasma coherence, resulting in high performance and long useful life of components, and which are suitable for use in a low-pressure environment (e.g., as in some aerospace applications) but are not limited thereto. In some embodiments, plasma generation and coherence maintaining techniques may be implemented to improve construction and/or operation of a traveling spark igniter that is configured to generate and propagate plasma using a Lorentz force and thermal force.

### TECHNICAL FIELD

The present disclosure relates generally to plasma generation as may be implemented in an ignition system, such as for use in a low to moderate pressure environment (e.g., for at least some aerospace applications), but not limited thereto. More particularly, the present disclosure relates to preserving coherence of plasma generated to provide high performance via prolonged effectiveness through coherence enabled dwell/residence time increase and long useful life of components (e.g., electrodes) while propagating plasma in a plasma generation system.

### BACKGROUND

A traveling spark igniter was previously developed for use in internal combustion engines with a focus on plasma formation and growth in a high-pressure and/or dense environment. Traveling spark igniters generate a plasma kernel by applying a high enough voltage between electrodes of the igniter to cause breakdown between the electrodes, at which point plasma is formed at the location of breakdown, and then the plasma kernel is propagated along the electrodes. The propagation is caused by thermal forces and a Lorentz force due to discharge current flowing between the electrodes through the plasma as it interacts with current flowing in the electrodes. Plasma propagation is desirable in some applications because movement of the plasma while formed increases the volume (e.g., swept and/or integrated over the propagation) retaining it's effectiveness longer by remaining coherent and away from physical structures, thus dissipating energy only to the immediately adjacent environment (in the case of ignition, an air-fuel mixture) in which ignition occurs as compared to a static plasma that remains entirely in one place before it recombines, transferring its energy substantially back into the solid structures from which it discharged.

More recently, traveling spark igniters have been refined for use in especially high pressure (e.g., advanced automobile engine) environments. In a high-pressure environment, following breakdown and prior to total recombination of the plasma, one or more follow-on pulses of current are applied to the electrodes to generate corresponding pulses of thermal and Lorentz force to propagate the formed plasma along the electrodes.

### SUMMARY

According to an aspect of the present disclosure, a method of plasma generation is provided, the method comprising: applying, to at least two electrodes, a breakdown voltage sufficient to induce breakdown between the at least two electrodes, resulting in formation of plasma in an initiation region between the at least two electrodes; and applying, to the at least two electrodes, after applying the breakdown voltage and before total recombination of the plasma, a follow-on current through the plasma, the follow-on current having a peak current that exceeds 450 amperes (A) at a time at least two microseconds following breakdown.

According to an aspect of the present disclosure, a method of plasma generation is provided, the method comprising: applying, to at least two electrodes, a breakdown voltage sufficient to induce breakdown between the at least two electrodes, resulting in formation of plasma between the at least two electrodes; and applying, after applying the breakdown voltage and before total recombination of the plasma, to the at least two electrodes, a follow-on current flowing through the plasma from a first point along the at least two electrodes to a second point along the at least two electrodes, the follow-on current having a pulse duration that is short enough to prevent material state alteration of the at least two electrodes at the first point and at the second point.

According to an aspect of the present disclosure, a method of plasma generation is provided, the method comprising: applying, to at least two electrodes, a breakdown voltage sufficient to induce breakdown between the at least two electrodes, resulting in formation of plasma between the at least two electrodes; and applying, to the at least two electrodes, after applying the breakdown voltage and before total recombination of the plasma, a follow-on current including a pulse having a rise time shorter than 10 μs.

According to an aspect of the present disclosure, a method of plasma generation, is provided, the method comprising: applying, to at least two electrodes: a breakdown voltage sufficient to induce breakdown between the at least two electrodes, resulting in formation of plasma between the at least two electrodes; and after the breakdown and before total recombination of the plasma, an amount of electrical energy sufficient to directionally propagate the plasma while keeping thermal expansion of the at least two electrodes below a threshold thermal expansion amount.

According to an aspect of the present disclosure, a method of plasma generation is provided, the method comprising: applying, to at least two electrodes, while at least distal tips of the at least two electrodes are only proximate to an environment having a pressure below 300 pounds per square inch (PSI): a breakdown voltage sufficient to induce breakdown between the at least two electrodes, resulting in formation of plasma between the at least two electrodes; and after the breakdown and before total recombination of the plasma, follow-on current sufficient to prevent total recombination of the plasma while controllably directionally propagating the plasma.

According to an aspect of the present disclosure, a method of ignition is provided, the method comprising: applying, to a plurality of electrodes, a breakdown voltage sufficient to induce breakdown between the plurality of electrodes, resulting in formation of plasma between the plurality of electrodes; and applying, to the plurality of electrodes, after applying the breakdown voltage and before total recombination of the plasma, a pulse of current having a peak current greater than 450 amperes (A), wherein the peak current is at a time at which current flowing between the plurality of electrodes would be lower than the peak current without application of the pulse of current.

According to an aspect of the present disclosure, a method of plasma generation is provided, the method comprising: applying, to at least two electrodes, a breakdown voltage sufficient to induce breakdown between the at least two electrodes, resulting in formation of plasma between the at least two electrodes; and applying, to the at least two electrodes, after the breakdown and before total recombination of the plasma, follow-on current sufficient to prevent total recombination of the plasma while controllably directionally propagating the plasma, wherein the breakdown voltage and the follow-on current collectively comprise an amount of energy exceeding one-third of a Joule (J).

The foregoing summary is provided by way of example and is not intended to be limiting. Moreover, aspects of the disclosure may be implemented individually on in any combination depending on the particular application.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 illustrates an example plasma generation system including a cross-section of at least two electrodes and circuitry configured to apply electrical energy to the electrode(s), according to some embodiments.

FIG. 2 illustrates example circuitry that may be included in the plasma generation system of FIG. 1, according to some embodiments.

FIG. 3A illustrates example application of follow-on current following breakdown in the plasma generation system of FIG. 1, according to some embodiments.

FIG. 3B illustrates an alternative example application of follow-on current following breakdown in the plasma generation system of FIG. 1, according to some embodiments.

### DETAILED DESCRIPTION

The present disclosure provides plasma generation techniques that may be implemented to maintain plasma coherence, resulting in high performance and long useful life of components, and which are suitable for use in a low pressure environment (e.g., as in some aerospace applications) but are not limited thereto. In some embodiments, plasma generation and coherence maintaining techniques may be implemented to improve construction and/or operation of a traveling spark igniter that is configured to generate and propagate plasma using a Lorentz force and thermal force.

As used herein, a “low-pressure environment” is an environment in which the pressure at the electrodes of a plasma generator (e.g., igniter) is 300 psi or below. By contrast, a “high-pressure environment” is an environment in which the pressure at the electrodes of a plasma generator (e.g., igniter) is above 300 psi.

Some aspects of the present disclosure leverage a recognition that plasma generation and propagation techniques developed for high-pressure environments may provide substandard or even inoperable performance in some relatively lower pressure environments. For example, in a high-pressure environment, the density of the environment is highly resistive to generation, growth, and propagation of plasma, which may necessitate a high breakdown voltage and the use of techniques dedicated to increasing growth and extending propagation of the plasma. In contrast, in a low-pressure environment, where plasma meets significantly less resistance to generation, growth, and propagation, such techniques would result in a substantially uncontrolled dispersion of energy and/or undesirably high thermal wear on (e.g., expansion of) components of the system. If plasma coherence is not maintained in at least some respects, the plasma may break apart and thus not grow and propagate as may be desired (e.g., for a traveling spark igniter) or rapidly dissipate to below effective parameters due to energy dispersion and greater surface area interaction. Moreover, while a large amount of electrical energy provided to a plasma generator may translate into a large Lorentz force, it may also, if not carefully controlled, lead to extensive wear on the plasma generator (e.g., electrodes).

To overcome the inapplicability of some high-pressure plasma generation techniques to other environments, the inventors have developed new plasma generation techniques that, in some aspects, achieve a balance of plasma propagation with thermal expansion of components of the system, which provide high performance and long useful life of the system components. For example, plasma generation techniques described herein may, in some aspects, maintain and propagate plasma while spreading the energy discharge used for plasma generation and propagation over a larger component area over time and limiting the amount of energy discharge at any given point over that component area. In this or in similar manner, components such as electrodes may wear slowly to achieve a long usable life with sacrificing high performance.

Some aspects of the present disclosure relate to applying, after breakdown, an amount of electrical energy sufficient to directionally propagate the plasma while keeping thermal expansion of the electrodes below a threshold thermal expansion amount (e.g., based on a pressure gradient in which the electrodes are disposed). It is recognized that thermal expansion of components of the system should be taken into consideration in addition to the desired directional propagation of the plasma, such as by limiting the amount of electrical energy applied to the components (e.g., at any given point along an electrode).

Some aspects of the present disclosure relate to applying one or more pulses of follow-on current having a pulse duration that is short enough to prevent material state alteration of components of the system (e.g., at points along the electrodes where current discharge via the plasma occurs). It is recognized that follow-on current pulse duration may be controlled to balance Lorentz force (e.g., for plasma propagation) with wear to components of the system, such as by applying follow-on current at a high enough amplitude and/or for a long enough time to achieve a desired Lorentz force but a short enough time that the locations of along the electrodes from which current is discharged into the plasma do not undergo an alteration of their material state, such as from solid to non-solid (e.g., liquid or vapor, through melting, vaporization, and/or sublimation). For instance, points along the electrodes at which plasma initiates may not undergo alteration of their material state at least until after plasma has propagated to distal tips of the electrodes, and/or at least until after the distal tips have undergone at least some material state alteration.

Some aspects of the present disclosure relate to applying one or more pulses of follow-on current having a high (e.g., 450 A or higher) peak current at a time at which the ordinarily expected current following breakdown (e.g., without applying the follow-on current) would otherwise be lower (e.g., lower than the high peak current at that time). It is recognized that, in a high-pressure environment, high current pulses of follow-on current may be unnecessary and cause undue wear to components of the system. But, outside of high-pressure environments, a high peak current pulse of follow-on current may be controlled to produce a high Lorentz force (e.g., for plasma propagation) while causing relatively low wear to components of the system. It is further appreciated that an even higher peak current (e.g., 550 A, 600 A, up to 1200 A) may be appropriate for some circumstances, such as where shorter rise and/or fall times are achievable and/or where pressure and/or temperature conditions will permit higher current without causing a significant increase in wear.

Some aspects of the present disclosure relate to applying one or more pulses of follow-on current including a pulse having a fast current rise time (e.g., shorter than 20 μs, 15 μs, 10 μs, or 5 μs depending on the embodiment) and/or a fall time that is as fast as is practically achievable. The rise time can relate to and/or be dependent upon the peak amplitude of current delivered by the pulse, such that higher currents delivered by the pulses may have a rise time that is no more than 100 μs for 600 A of current or, in other embodiments that is no more than 60 μs for 600 A. The current rise times of the pulses can be characterized based on a rise time rate rather than a total rise time; for example, as a number of microseconds per 100 A of current. In some embodiments, the circuitry is configured to supply current at a rise time rate of at least 17 μs per 100 A (17 μs/100 A). Various other embodiments may provide a current rise time rate of at least 10 μs/100 A, at least 13 μs/100 A, or at least 20 μs/100 A. These rise times can be achieved by suitable design and selection of power storage devices (e.g., capacitors), magnetics (e.g., transformer capacity), and switch devices (e.g., transistors) to supply the current levels desirable or needed for a particular application of the plasma generating system.

In this way, the follow-on current pulse rise and/or fall times may be controlled to achieve a high Lorentz force over a relatively short amount of time, thereby producing a relatively low amount of wear on locations along the electrodes where energy discharges into the plasma. For example, applying a same amount of energy (e.g., current integrated over time) to the electrodes over a shorter amount of time may achieve a substantially higher Lorentz force while causing less wear on the electrodes than if the same amount of energy were applied over a longer amount of time.

Some aspects of the present disclosure relate to applying a controlled discharge (e.g., a breakdown voltage and follow-on current achieving a high discharge current through formed plasma) that collectively comprises an amount of energy exceeding ⅓ J with the intent of the energy delivery being structured to higher Lorentz force to thermal force ratio for a given energy compared to high pressure environment applications (e.g., exceeding ½ J). It is recognized that, in high-pressure environments, applying so much as ⅓ J for plasma generation will not produce coherent plasma with propagation beyond 0.2 inches beyond the distal tips due to the resistance present from the dense environment into which current is discharged. In contrast, where high-pressure performance is not in particular focus, techniques described herein may facilitate applying significant amounts of energy (e.g., ⅓ J, 0.5 J, 2 J, 4 J, 10 J) to electrodes of a plasma generation system and maintaining plasma coherence while achieving significant plasma propagation by skewing the energy delivery toward high Lorentz force to thermal force ratio for a given energy input, the plasma will tend to stay together as it projects.

Some aspects of the present disclosure relate to applying follow-on current to electrodes that are only proximate, at least in part (e.g., their distal tips), to an environment having a pressure below 300 PSI, such as below 150 PSI. It is recognized that follow-on current may be beneficially and controllably applied to prevent total recombination of and/or directionally propagate plasma even in low-pressure environments, such as by (but not limited to) leveraging one or more other aspects described above.

It should be appreciated that, according to various embodiments, aspects of the present disclosure may be implemented individually or in suitable combination.

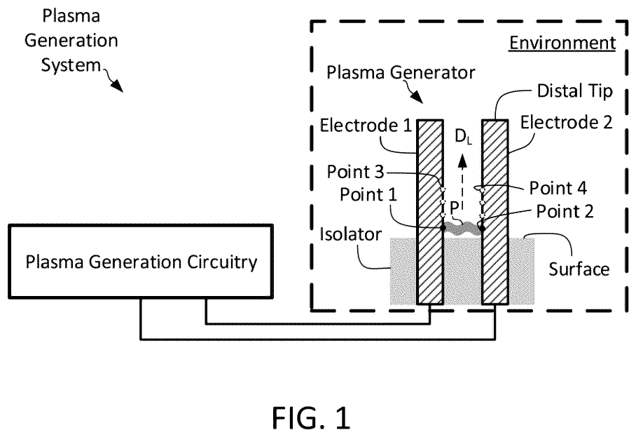

Turning to the figures, FIG. 1 illustrates an example plasma generation system including at least two electrodes and circuitry configured to apply electrical energy to the electrode(s), according to some embodiments.

As shown in FIG. 1, a plasma generator is disposed at least in part in an environment. For example, in FIG. 1, the plasma generator includes at least two electrodes (e.g., additional electrodes may be present though not shown). In some embodiments, the environment may be an ignition environment in which it is desired to form and/or propagate plasma to ignite an air-fuel mixture. In the illustrated embodiment, at least distal tips of the electrodes are proximate to the environment, though in other cases, more of the electrodes may be exposed to the environment. In some embodiments, the illustrated environment may be a low-pressure environment. For example, the plasma generation system may be configured for use in some aerospace applications, such as for ignition within certain aircraft engine environments, including for instance at flight altitude. In some embodiments, a plasma generation system may be configured to generate and maintain coherent plasma at pressures up to (e.g., only up to) 300 PSI, 175 PSI, or 150 PSI. In some embodiments, a plasma generation system may be configured for operation at a low-pressure value (e.g., 150 PSI) in that the plasma generation system is capable of controllably and coherently forming, maintaining, and propagating plasma at least up to that low-pressure value.

In some embodiments, a plasma generation system may be configured to apply across at least two electrodes, a breakdown voltage sufficient to induce breakdown between the electrode(s), resulting in formation of plasma between the electrode(s). For example, as shown in FIG. 1, a first electrode 1 and a second electrode 2 may receive the breakdown voltage thereacross, such as by having the breakdown voltage applied to one electrode and a reference voltage (e.g., ground) applied to the other electrode. For instance, the breakdown voltage may be sufficient that a dielectric (e.g., air gap) between the electrodes may breakdown and form plasma that provides a conductive path between the electrodes through which current may flow.

In some embodiments, breakdown between the electrode(s) may result in formation of plasma in an initiation region. For example, in FIG. 1, a plasma kernel P is shown formed between the electrodes 1 and 2 between a first point 1 and a second point 2. For instance, the first point 1 and the second point 2 may form the initiation region with initial plasma formation therebetween. In some embodiments, the initiation region may be a region at which electrical discharge between the electrodes through the broken-down dielectric begins, thereby providing a conductive path within that region through the plasma where the dielectric broke down. For example, the initiation region may be where, prior to breakdown (and/or prior to formation of plasma and/or prior to system-induced ionization), impedance is lowest between the electrodes. In the illustrated embodiment, the electrodes 1 and 2 are separated by an isolator, which may include ceramic, such that a surface of the isolator provides a lowest impedance path between the electrodes 1 and 2. For instance, the initiation region may be at or proximate the surface of the isolator. In some embodiments, the surface of the isolator may be treated (e.g., with a conductive agent that induces semiconductive behavior) to further reduce the impedance proximate the surface, as this may reduce the breakdown voltage needed to initiate plasma. In some embodiments that are configured to propagate plasma along a length of the electrodes, an initiation region may be a first location from which the plasma is propagated (e.g., terminating at least at the distal tips of the electrodes).

It should be appreciated that the electrodes may not be separated along their entire lengths by any given isolator and/or alternative or additional material (e.g., including a gap) may be between the electrodes along at least a portion of their length, such as due to manufacturing tolerance.

It should be appreciated that multiple initiation regions may be present in a plasma generator as formed and/or configured for use. For example, where electrodes are manufactured with portions projecting towards one another, such portions may provide a lowest impedance path between the electrodes prior to at least some applications of the breakdown voltage. In the same example, portions projecting towards one another may be destroyed after several applications of the breakdown voltage such that other points along the electrodes have a lowest impedance path between the electrodes. Any or each of such points may be considered an initiation region in which the electrodes are configured to initially form plasma following application of a breakdown voltage, even before destruction of some portions that form an initiation region.

According to various embodiments, the electrode(s) may have any suitable configuration. For example, electrodes may be present in a coaxial configuration. In the same or another example, more than two electrodes may be present, such as with some of the electrodes configured as anodes (e.g., receiving the breakdown voltage) and some of the electrodes configured as cathodes (e.g., receiving a reference voltage, or vice versa). For instance, in a rail configuration, multiple electrodes may be spaced from one another and/or from another electrode (e.g., a central electrode), such as with one electrode configured as an inner electrode and other electrodes configured as outer electrodes.

According to one aspect of the present disclosure, a plasma generation system such as shown in FIG. 1 may be configured to apply to the electrode(s), after applying the breakdown voltage and before total recombination of the plasma, a follow-on current through the plasma. For example, following breakdown and without application of follow-on current, the plasma may naturally recombine as time goes on, which results in a rapid reduction in the amount of current flowing through the plasma. For instance, the follow-on current may flow through the plasma thereby sustaining the plasma and maintaining the conductive path therethrough. Moreover, as described further herein, the follow-on current may create a Lorentz force that propagates the plasma along the electrode(s).

In some embodiments, the follow-on current may have a peak current that exceeds 450 A at a time at least two microseconds following breakdown. The example, as described above, some aspects of the present disclosure leverage the recognition that applying a high peak current (e.g., for a short period of time and/or in a low-pressure environment) may produce a large Lorentz force (e.g., for propagating the plasma along the electrodes) while limiting wear on the electrodes (e.g., at any particular point along the electrodes). In some embodiments, a peak current exceeding 450 A may provide a sufficient balance of Lorentz force with wear on the electrodes and coherence of the resulting plasma, whereas in other cases, temperature and/or pressure conditions and/or material used in the electrodes may permit an even larger peak current, such as exceeding 550 A, exceeding 600 A, or higher, to achieve an even higher Lorentz force.

In some embodiments, after applying the breakdown voltage and before total recombination of the plasma, a pulse of current may be applied having a peak current greater than 450 A at a time at which current flowing between the electrode(s) would be lower than the peak current without application of the pulse of current. For example, at least two microseconds following breakdown and without the follow-on current, the current level through the plasma from applying the breakdown voltage may be rapidly falling. As such, without applying the follow-on current, less than 450 A, such as a much smaller amount of current on the order of a few A, might otherwise be flowing through the plasma at the time the follow-on current has the peak current level. In another example, the follow-on current may be applied while the current rapidly falling following breakdown is or exceeds 450 A. For instance, the follow-on current may supply a further 450 A beyond the level of current flowing through the plasma at the time the follow-on current has the peak current level.

In some embodiments, applying the pulse of current may include propagating the plasma along a length of the electrode(s). For example, in a traveling spark igniter configuration, current flowing through the electrodes 1 and 2 may cause a Lorentz force to push the plasma along the length of the electrodes 1 and 2 (e.g., along the length direction D_{L}). For instance, following application of a pulse of current, the plasma kernel P shown in FIG. 1 may move in the length direction D_{L} towards distal tips of the electrodes 1 and 2. In some embodiments, applying a sequence of multiple pulses of follow-on current prior to total recombination of the plasma may sustain propagation the plasma kernel P with each pulse beyond any initial propagation that may be induced by application of the breakdown voltage.

According to another aspect of the present disclosure, a plasma generation system such as shown in FIG. 1 may be configured to, apply, to the electrode(s), after applying the breakdown voltage and before total recombination of the plasma, a follow-on current having a pulse duration that is short enough to prevent material state alteration of at least a portion of the electrode(s). For example, material state alteration may include a material state change from a first material state (e.g., solid) to a second material state (e.g., non-solid). For instance, upon application of a significant amount of electrical energy to an electrode (e.g., as may occur during breakdown and/or application of follow-on current), material of the electrode (e.g., where electrical discharge into the plasma occurs) may heat to the point of liquification, by melting into liquid, vaporization, by transitioning from solid to liquid to vapor, and/or sublimation by transitioning directly from solid to vapor. In contrast, however, according to some aspects described herein, a pulse duration may be used such that material of the electrode does not heat so much as undergo material state alteration. For instance, application of electrical energy to any given point along the electrode(s) (e.g., as the plasma kernel P propagates in the length direction D_{L}) may be made short enough to spread heat and resulting wear over the electrode(s) to prevent (e.g., at least prolong) material state alteration, thereby improving the longevity of the electrode(s).

In some embodiments, the pulse duration may be short enough to prevent material of the electrode(s) at the first point and at the second point from changing from a first material state to a second material state, such as from solid to non-solid (e.g., liquid or vapor). For example, the follow-on current may flow between the first point 1 and the second point 2 in FIG. 1, which may be where plasma initiates, and/or the follow-on current may flow through another pair of points (e.g., spaced along the electrodes in the length direction D_{L}), such as where plasma propagates at least some distance between breakdown and application of the follow-on current. In some embodiments, the pulse duration may be short enough to prevent material alteration of the electrode(s) at the first point 1 and at the second point 2. In the illustrated embodiment, the first point 1 and the second point 2 are prior to distal tips of the electrodes along a length of the electrode(s) shown in a length direction D_{L} in FIG. 1.

In other embodiments, the first point 1 and the second point 2 may be at least prior to the distal tip of one of the electrodes, such as where the electrodes have different lengths (e.g., resulting in their distal tips being offset in the length direction D_{L}). In some embodiments, the pulse duration may be short enough to prevent material state alteration at the first point at the first point 1 and at the second point 2 at least prior to material state alteration at the distal tip(s).

In some embodiments, a plasma generation system such as shown in FIG. 1 may be further configured to apply, to the electrode(s), second follow-on current flowing through the plasma. For example, the follow-on current (e.g., flowing between the first point 1 and the second point 2) may include a first pulse of current and the second follow-on current may include a second pulse of current applied at a time later then the first pulse of current. For instance, as shown in FIG. 1, the first electrode further has a third point 3 along the electrode(s) and the second electrode further has a fourth point 4 along the electrode(s). In some embodiments, the second follow-on current may flow through the plasma from the third point 3 to the fourth point 4. In the illustrated embodiment, the third point 3 and the fourth point 4 are spaced along a length (e.g., in the length direction D_{L}) of the electrode(s) from the first point 1 and the second point 2.

In some embodiments, the second follow-on current may have a pulse duration that is short enough to prevent material state alteration of the electrode(s) at the third point 3 and at the fourth point 4. For example, follow-on current (e.g., including the second follow-on current) may be applied such that, as plasma propagates along the electrodes 1 and 2, points along the electrodes 1 and 2 do not undergo material state alteration. For instance, a pulse duration of follow-on current applied to the electrodes 1 and 2 may be short enough to prevent material state alteration of the electrode 1 and 2 at the first point 1 and the second point 2 (and/or at the third point 3 and the fourth point 4) at least until plasma propagated from the first point 1 and the second point 2 reaches a distal tip of the electrodes 1 and 2.

In some embodiments, applying the follow-on current to the electrode(s) may include propagating the plasma along a length of the electrode(s), such as described above for applying a pulse of current. For example, applying the follow-on current through the plasma may include propagating the plasma along the length of the electrodes 1 and 2 in the length direction D_{L} in FIG. 1.

According to another aspect of the present disclosure, a plasma generation system such as shown in FIG. 1 may be configured to apply, to the electrode(s), after the breakdown and before total recombination of the plasma, an amount of electrical energy sufficient to directionally propagate the plasma while keeping thermal expansion of the electrode(s) below a threshold thermal expansion amount. For example, the threshold thermal expansion amount may be based on a pressure gradient in which the electrode(s) are disposed when the amount of electrical energy is applied. It is recognized that electrical energy applied to the electrodes may form, sustain, and even propagate plasma but that thermal expansion of the electrodes may be considered and balanced. In some embodiments, follow-on current applied to the electrode(s) may have an amount of electrical energy that is sufficient to controllably directionally propagate the plasma while keeping thermal expansion of the at least two electrodes below the threshold thermal expansion amount.

According to another aspect of the present disclosure, a plasma generation system such as shown in FIG. 1 may be configured to apply follow-on current to the electrode(s) while at least distal tips of the electrode(s) are only proximate to an environment having a pressure below 300 PSI. For example, the environment of FIG. 1 may be a low-pressure environment in which pressure does not exceed 300 PSI, or at least in which plasma is not generated while pressure exceeds 300 PSI. In some embodiments, the follow-on current may be applied after breakdown and before total recombination of the plasma and/or may be sufficient to prevent total recombination of the plasma while controllably directionally propagating the plasma, such as described above. In some embodiments, the pressure may be below 175 PSI, 150 PSI, and/or below 100 PSI. It is recognized that considerations for an amount of energy delivered in an environment in which pressure does not exceed 300 PSI (or a lower amount such as 175 PSI) are significantly different from an environment in which plasma may be generated, sustained, and/or propagated with high-pressure, and thus careful consideration of energy levels may be warranted, such as described herein.

According to another aspect of the present disclosure, a plasma generation system such as shown in FIG. 1 may be configured to apply, to the electrode(s), a breakdown voltage and follow-on current that collectively include an amount of energy exceeding ⅓ J. For example, the follow-on current may be sufficient to prevent total recombination of the plasma while controllably directionally propagating the plasma such as described herein. According to various embodiments, the amount of energy may exceed 2 J, 4 J, and/or 10 J. For example, the amount of energy may be sufficient to controllably directionally propagate the plasma while keeping thermal expansion of the electrode(s) below a threshold thermal expansion amount, such as described herein. It is appreciated that ⅓ J or more may be a quantity of energy that is not desirable to apply to electrodes in high-pressure, such as given the resistance to plasma formation and propagation in high-pressure and the extent to which such an amount of energy may destroy the electrodes while in high-pressure.

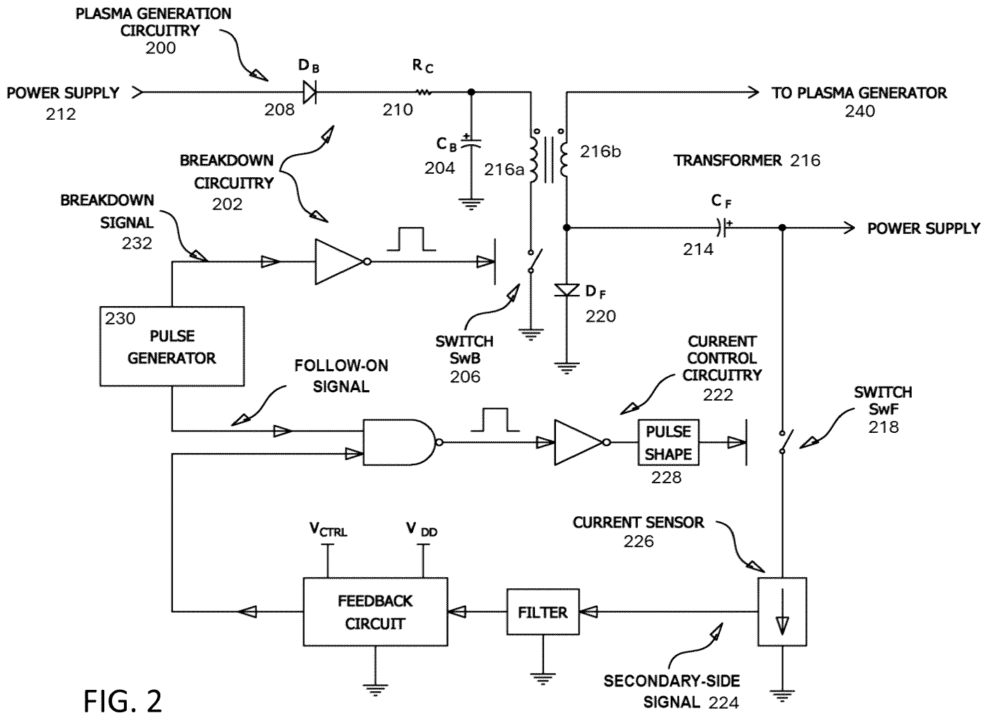

As shown in FIG. 1, the illustrated plasma generation system includes plasma generation circuitry coupled to the plasma generator, which may be configured to apply breakdown voltage and/or follow-on energy to the plasma generator. A further example of plasma generation circuitry is shown in FIG. 2 and described further herein.

FIG. 2 illustrates example circuitry 200 that may be configured to apply a controlled pulse of electrical energy to a plasma generator that may be included in the plasma generation system of FIG. 1, according to some embodiments.

In FIG. 2, the plasma generation circuitry 200 includes breakdown circuitry 202, which may be configured to apply a breakdown voltage to electrodes (e.g., electrodes 1 and 2 of FIG. 1) of a plasma generator 240 using energy stored in an energy storage device (e.g., other than the energy storage device used for applying follow-on energy but not limited thereto). For example, in FIG. 2, the breakdown circuitry 202 includes a breakdown capacitance 204 coupled to a breakdown switch 206 via a primary coil 216a of a transformer 216. For instance, upon closing of the breakdown switch 206, energy stored in the breakdown capacitance 204 may pass through the primary coil 216a and thereby draw current through a secondary coil 216b of the transformer 216 to the plasma generator, which may produce a voltage across the secondary coil 216b sufficient to cause breakdown (e.g., due to a turns ratio of the transformer and the rate at which current is changing at least in the secondary coil 216b). In the illustrated embodiment, a pulse generator 230 is further included to produce a breakdown signal 232 applied to the breakdown switch 206 to controllably initiate breakdown.

In the illustrated embodiment, breakdown capacitance 204 may be charged via a breakdown diode 208 and a charging resistor 210 from a power supply 212. For example, after breakdown, the breakdown switch 206 may be opened to permit recharging of the breakdown capacitance 204 without the charging current passing through the transformer to the switch 206. In other embodiments, charging current from the power supply 212 may be applied to the primary coil 216a through a diode that bypasses the switch, such that the switch may remain closed while charging the capacitance.

In some embodiments, applying a breakdown voltage to the electrode(s) of a plasma generator may include applying the breakdown voltage from an energy storage device to the electrode(s) via a transformer. For example, as shown in FIG. 2, the transformer further couples a follow-on capacitance 214 to the plasma generator 240 on the secondary side. In some embodiments, upon closing of the breakdown switch 206, current may flow from the follow-on capacitance 214 through the secondary coil 216b of the transformer 216 to the plasma generator 240. While the illustrated embodiment shows application of breakdown energy to the primary coil 216a μsing a different energy storage device than application of breakdown energy to the secondary coil 216b, a shared energy storage device may be used to apply energy to both the primary coil 216a and the secondary coil 216b in other embodiments, as the present disclosure is not so limited.

Similarly, in some embodiments, applying follow-on electrical energy to the electrode(s) may include applying the follow-on electrical energy from an energy storage device to the electrode(s) via a transformer. For example, after breakdown, additional current may flow from the follow-on capacitance 214 to the plasma generator 240 via the secondary coil 216b of the transformer 216, which is the same path as the breakdown voltage in the illustrated embodiment. In other embodiments, separate energy storage devices (e.g., capacitances) may be used for application of breakdown voltage and follow-on energy.

In some embodiments, the transformer 216 may have a saturable core. For example, the transformer 216 may have a low turns ratio (e.g., 37:1) to produce a low breakdown voltage and saturate upon application of sufficient current through the secondary coil 216b. For instance, a transformer core may be at least partially saturated when the secondary coil 216b inductance becomes significantly less inductive due to the core (e.g., ferromagnetic material about which the secondary coil is wound) taking on behavior of air, and/or the secondary coil 216b becoming substantially decoupled from the primary coil.

In some embodiments, the (e.g., saturable) core of the transformer 216 may be saturated by application of the breakdown voltage and may remain at least partially saturated at least through (e.g., controlled) application of electrical energy following breakdown. For example, by keeping at least partial saturation of the transformer 216 at least through application of follow-on electrical energy, current applied to the secondary coil 216b during at least partial saturation may encounter a low inductance and produce a low voltage drop across the secondary coil 216b while passing through to the plasma generator 240 to flow through the plasma.

In some embodiments, applying the breakdown voltage and/or applying the follow-on current may include closing a switching element coupled in a path from the plasma generator that includes an energy storage device and a transformer. For example, in FIG. 2, the plasma generation circuitry 200 further includes a switch 218 coupled in a path from the plasma generator 240 through the secondary coil 216b of the transformer 216 to the follow-on capacitance 214 and further to ground via the switch 218. In other embodiments, the switch 218 may be coupled between the plasma generator 240 and the secondary coil 216b of the transformer 216, and/or between the secondary coil 216b of the transformer 216 and an energy storage device. While a single switch 218 is shown in FIG. 2, it should be appreciated that multiple switches may be included in a switching element, such as multiple series and/or parallel connected switches. According to various embodiments, a switching element may include an isolated gate bipolar transistor (IGBT), a thyristor such as a MOS-controlled thyristor (MCT).

In the illustrated embodiment, a diode 220 is further coupled to a point between the follow-on capacitance 204 and the secondary coil 216b of the transformer 216, such as to create a reference voltage point (e.g., close to 1 V above ground in FIG. 2) between the follow-on capacitance 204 and the secondary coil 216b while the switch 218 is closed. Also shown in FIG. 2, a power supply 236 is coupled to the follow-on capacitance 214. For example, a blocking diode (not shown) may be coupled between the follow-on capacitance 214 and the power supply 236 to permit charging of the follow-on capacitance 214 and to block the flow of electrical energy from the follow-on capacitance 214 to the power supply 236.

In some embodiments, the plasma generation circuitry may be configured to actively control application of follow-on energy to the plasma generator. For example, in FIG. 2, the plasma generation circuitry 200 further includes current control circuitry 222. In the illustrated embodiment, the current control circuitry 222 includes a feedback loop incorporating feedback from a current sensor 226 into a secondary-side signal 224. For instance, the feedback loop may be configured to regulate an amount of current flowing through the secondary coil 216b (e.g., corresponding to current flowing through the plasma) by comparing a sensed amount of current flowing through the switch 218 to a threshold current level (e.g., set by a control voltage V_{CTRL}), and enable the secondary side signal to turn on the switch 218 using a follow-on control signal 234 based on the sensed amount of current. In the illustrated embodiment, pulse shaping 228 is also applied, such as may be used to control a rise time and/or fall time of a pulse of follow-on current.

It should be appreciated that other plasma generation circuitry configurations may be used depending on the application. For example, where a sufficiently low breakdown voltage may be used (e.g., where a treated ceramic isolator surface provides for a very low breakdown voltage), the breakdown voltage and/or follow-on current may be delivered directly to the plasma generator from an energy storage device, such as without first passing through an inductance. For instance, an energy storage device may be coupled directly to a plasma generator by a switching element.

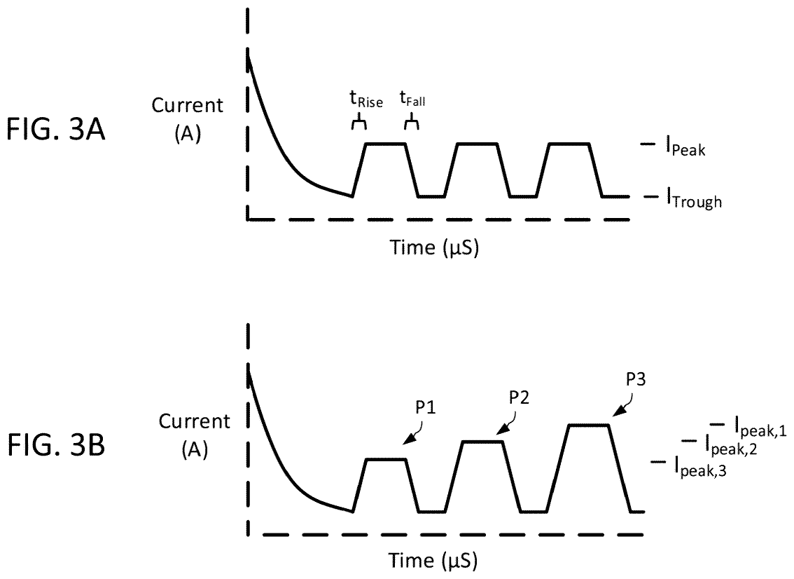

FIG. 3A illustrates example application of follow-on current following breakdown in the plasma generation system of FIG. 1, according to some embodiments.

As shown in FIG. 3A, breakdown may be followed by a decline in current through the plasma, such as due to at least partial plasma recombination. In the illustrated embodiment, a sequence of at least three pulses of follow-on current are applied (e.g., additional pulses may be applied after the illustrated timeframe). For example, the follow-on current pulses shown in FIG. 3A may be applied using circuitry shown in FIG. 2, though other circuitry configurations could be used. It should be appreciated that fewer pulses than illustrated may be applied, depending on the embodiment.

In some embodiments, applying follow-on current may include altering a rate of current decay through the plasma with respect to current decay following breakdown without the follow-on current. For example, as shown in FIG. 3A, the current decay following breakdown is altered by the three pulses of follow-on current. In some embodiments, altering the rate of current decay may include actively applying follow-on current to produce a higher current than would be flowing through the plasma following breakdown without applying the follow-on current. For example, in FIG. 3A, current flowing through the plasma is higher at each illustrated pulse than the current would be according to the decay curve that precedes the pulses. For instance, application of follow-on current may include using at least one active circuit element, such as a switching element.

In some embodiments, applying follow-on current may include applying, to the electrode(s), at least two pulses of current (e.g., having at least the peak current described herein as exceeding 450 A). For example, in FIG. 3A, each pulse is shown having a peak current I_{Peak}, which is the same for each pulse in FIG. 3A, though need not be (e.g., see FIG. 3B). For instance, in FIG. 3A, each illustrated pulse may have a peak current I_{Peak} exceeding 450 A, and at least one of the pulses shown in FIG. 3A may reach the peak current I_{Peak} at least two microseconds following breakdown. It should be appreciated that while square pulses (e.g., trapezoidal pulses due to nonzero rise and fall times in a practical implementation) are shown in FIG. 3A, other pulse shapes may be used such as triangle and/or sinusoidal pulses.

In some embodiments, applying the follow-on current and/or pulse of current may be before a next application of the breakdown voltage to the electrode(s). For example, as shown in FIG. 3A, the current through the plasma does not rise to its post-breakdown decay level before application of the illustrated pulses. It should be appreciated that some at least partial recombination of the plasma may occur prior to at least some applied follow-on current, which may result in a breakdown voltage lower than the applied breakdown voltage being applied (e.g., using a voltage across the secondary coil of the transformer, which may become at least partially unsaturated) before at least some of the applied follow-on current.

According to another aspect of the present disclosure, a follow-on current may have a pulse having a rise time shorter than 10 μs. For example, the rise time may be shorter than 5 μs, and/or shorter than 3 μs. For example, in FIG. 3A, the first illustrated pulse has a rise time t_{Rise} and a fall time t_{Fall}. In some embodiments, the rise time t_{Rise} and/or the fall time t_{Fall} may be controlled to produce a pulse of follow-on current that contributes a sufficient Lorentz force (e.g., for plasma propagation) and/or at least prevents total recombination of the plasma while limiting time during which a given point along the electrodes is exposed to wear. It is recognized that rise and/or fall times of pulses of follow-on current may be a useful tool for balancing wear on the electrodes with beneficial application of electrical energy to the electrodes.

In some embodiments, at least two pulses of current, including a pulse having the rise time and/or the fall time (e.g., shorter than 10 μs, and/or shorter than 5 μs), may be applied at a time at least two microseconds following breakdown. For example, in FIG. 3A, the first illustrated pulse may be applied at a time at least two microseconds following breakdown and include such a short rise time and/or fall time. Alternatively or additionally, other ones of the illustrated pulses may be applied at a time at least two microseconds following breakdown and include such a short rise time and/or fall time. In the illustrated embodiment, each pulse is shown having the same rise time and fall time, though that need not be the case (e.g., see FIG. 3B).

In some embodiments, follow-on current including a pulse having such a short rise time and/or fall time may be delivered using circuitry described herein including in connection with FIG. 2. For example, the follow-on current may be applied from an energy storage device via a transformer having a saturable core, and the core may remain at least partially saturated at least through application of the follow-on current. In some embodiments, pulse shaping and/or current monitoring feedback may be used to achieve a desired rise time and/or fall time. In some embodiments, a switching element coupled in a path from the plasma generator that includes the energy storage device and the transformer.

In some embodiments, applying follow-on current through the plasma including such a short rise time and/or fall time may further include propagating the plasma along a length of the electrodes, such as described herein. For example, controlling the rise and/or fall time may be useful in achieving a Lorentz force for propagating the plasma in a controllable manner and while limiting wear at any point along the electrodes.

In some embodiments, at least distal tips of the electrodes may be only proximate to an environment having a pressure below 300 PSI (or below 175 PSI, or below 150 PSI) while the follow-on current (e.g., a pulse thereof having such a short rise and/or all time) is applied.

In some embodiments, at least two pulses of follow-on current (e.g., the three illustrated pulses) may (e.g., alone or in combination with the breakdown voltage) contain an amount of energy sufficient to controllably propagate plasma along the electrodes without causing beyond a threshold amount of thermal expansion, such as described herein.

In some embodiments, as an alternative or in addition to having a relatively short rise time and/or fall time, a pulse of follow-on current such as shown in FIG. 3A may have a current rate-of-change with an absolute value exceeding 90 A/μs (e.g., exceeding 130 A/μs). For example, the first illustrated pulse is shown changing from a low current level I_{Trough} to the peak current level I_{Peak} linearly over a rise time t_{Rise}, resulting in a current rate-of-change over the rise time t_{Rise} of (I_{Peak}−I_{Trough})/t_{Rise}. Similarly, the illustrated fall time t_{Fall} results in a current rate of change over the fall time t_{Fall} of (I_{Trough}−I_{Peak})/t_{Fall}. While the current rates-of-change in the illustrated example have opposite signs for rise and fall, they have a same absolute value. It should be appreciated that a current rate-of-change may be instantaneous and/or derived from a non-linear change in current (e.g., a sinusoidal peak) such as using a slope of a tangent line. It should be further appreciated that a current rate-of-change may have a different absolute value for a rise time of a pulse and for a fall time of a pulse, such as where a pulse is asymmetrical with time as compared to the example shown in FIG. 3A.

FIG. 3B illustrates an alternative example application of follow-on current following breakdown in the plasma generation system of FIG. 1, according to some embodiments.

In some embodiments, pulses of follow-on current may have different peak currents. For example, in FIG. 3B, a first pulse P1 is followed by a second pulse P2 having a second peak current I_{peak,2} that is higher than a first peak current I_{peak,1} of the first pulse P1. For example, the pulses of follow-on current may, at least for some pulses in a follow-on sequence, increase in peak current over time.

In some embodiments, a first follow-on current applied to the electrode(s) (e.g., at a first pair of points) may include the first pulse P1 and a second follow-on current applied at to the electrode(s) (e.g., at a second pair of points closer to the distal tips than the first pair of points are) may include the second pulse P2. For example, the second follow-on current may be applied through the plasma farther along a length of the electrode(s) (e.g., in length direction D_{L} in FIG. 1) as part of propagating the plasma along the length of the electrode(s).

In some embodiments, more than two pulses of follow-on current may be applied before a next application of the breakdown voltage. For example, in FIG. 3, the second pulse P2 is followed by a third pulse P3. In the illustrated embodiment, the third pulse P3 has a third peak current I_{peak,3} that is shown higher than the first peak current I_{peak,1} and the second peak current I_{peak,2}, though in other embodiments the sequence of pulses may differ in relative peak current. For instance, the second pulse P2 may have a peak current higher than the first pulse P1 and the third pulse P3.

The foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

### INVENTIVE ASPECTS

The following paragraphs are statements defining various aspects of the invention in claim format for present or future use as patent claims. These paragraphs represent at least some of the inventive aspects for which protection is sought.

1. A method of plasma generation, the method comprising:
applying, to at least two electrodes, a breakdown voltage sufficient to induce breakdown between the at least two electrodes, resulting in formation of plasma in an initiation region between the at least two electrodes; and
applying, to the at least two electrodes, after applying the breakdown voltage and before total recombination of the plasma, a follow-on current through the plasma, the follow-on current having a peak current that exceeds 450 amperes (A) at a time at least two microseconds following breakdown.

2. The method of inventive aspect 1, wherein applying the follow-on current comprises altering a rate of current decay through the plasma with respect to current decay following breakdown without the follow-on current.

3. The method of inventive aspect 2, wherein altering the rate of current decay comprises actively applying the follow-on current to produce a higher current than would be flowing through the plasma following breakdown without applying the follow-on current.

4. The method of inventive aspect 1 or 2, wherein applying the follow-on current is before a next application of the breakdown voltage to the at least two electrodes.

5. The method of any one of inventive aspects 1 to 4, wherein the peak current exceeds 550 A at the time at least two microseconds following breakdown.

6. The method of any one of inventive aspects 1 to 4, wherein the peak current exceeds 600 A at the time at least two microseconds following breakdown.

7. The method of any one of inventive aspects 1 to 6, wherein applying the follow-on current comprises applying, to the at least two electrodes, at least two pulses of current having at least the peak current, wherein a first pulse of current of the at least two pulses of current has the peak current at the time at least two microseconds following breakdown.

8. The method of inventive aspect 7, wherein a second pulse of current of the at least two pulses of current has a second peak current that is different from the peak current.

9. The method of inventive aspect 8, wherein one of the peak current and the second peak current occurs after and is higher in current than the other of the peak current and the second peak current.

10. The method of any one of inventive aspects 1 to 9, wherein:
applying the breakdown voltage comprises applying the breakdown voltage from an energy storage device to the at least two electrodes via a transformer having a saturable core;
applying the follow-on current comprises applying the follow-on current from the energy storage device to the at least two electrodes via the transformer; and
the saturable core is saturated by application of the breakdown voltage and remains at least partially saturated at least through application of the follow-on current.

11. The method of inventive aspect 10, wherein each of applying the breakdown voltage and applying the follow-on current comprises closing a switching element coupled in a path from the at least two electrodes that includes the energy storage device and the transformer.

12. The method of any one of inventive aspects 1 to 11, wherein applying the follow-on current through the plasma comprises propagating the plasma along a length of the at least two electrodes.

13. The method of any one of inventive aspects 1 to 12, wherein at least distal tips of the at least two electrodes are only proximate to an environment having a pressure below 300 pounds per square inch (PSI) while the breakdown voltage and the follow-on current are applied.

14. The method of any one of inventive aspects 1 to 13, wherein at least distal tips of the at least two electrodes are only proximate to an environment having a pressure below 150 pounds per square inch (PSI) while the breakdown voltage and the follow-on current are applied.

15. A plasma generation system comprising at least two electrodes and circuitry configured to perform the method of any one of inventive aspects 1 to 14.

16. A method of plasma generation, the method comprising:
applying, to at least two electrodes, a breakdown voltage sufficient to induce breakdown between the at least two electrodes, resulting in formation of plasma between the at least two electrodes; and
applying, after applying the breakdown voltage and before total recombination of the plasma, to the at least two electrodes, a follow-on current flowing through the plasma from a first point along the at least two electrodes to a second point along the at least two electrodes, the follow-on current having a pulse duration that is short enough to prevent material state alteration of the at least two electrodes at the first point and at the second point.

17. The method of inventive aspect 16, wherein the first point and the second point are prior to a distal tip of the at least two electrodes along a length of the at least two electrodes, and the pulse duration is short enough to prevent material state alteration at the first point and at the second point at least prior to material state alteration at the distal tip.

18. The method of inventive aspect 16, wherein the pulse duration is short enough to prevent material of the at least two electrodes at the first point and at the second point from changing from a first material state to a second material state.

19. The method of inventive aspect 18, wherein the first material state is solid and the second material state is liquid or vapor.

20. The method of any one of inventive aspects 16 to 19, further comprising:
applying, to the at least two electrodes, second follow-on current flowing through the plasma from a third point along the at least two electrodes to a fourth point along the at least two electrodes,
wherein the third point and the fourth point are spaced along a length of the at least two electrodes from the first point and the second point, and
wherein the second follow-on current has a pulse duration that is short enough to prevent material state alteration of the at least two electrodes at the third point and at the fourth point.

21. The method of inventive aspect 20, wherein applying the follow-on current and the second follow-on current comprises propagating the plasma along the length of the at least two electrodes.

22. The method of inventive aspect 21, wherein the pulse duration is short enough to prevent material state alteration of the at least two electrodes at the first point and the second point at least until plasma propagated from the first point and the second point reaches a distal tip of the at least two electrodes.

23. The method of any one of inventive aspects 20 to 22, wherein the follow-on current has a first peak current and the second follow-on current has a second peak current that is different from the first peak current.

24. The method of inventive aspect 23, wherein the second peak current is higher in current than the first peak current.

25. The method of any one of inventive aspects 16 to 21, wherein applying the follow-on current is before a next application of the breakdown voltage to the at least two electrodes.

26. The method of inventive aspect 16 or 18, wherein the follow-on current comprises a peak current exceeding 450 amperes (A).

27. The method of any one of inventive aspects 16 to 26, wherein:
applying the breakdown voltage comprises applying the breakdown voltage from an energy storage device to the at least two electrodes via a transformer having a saturable core;
applying the follow-on current comprises applying the follow-on current from the energy storage device to the at least two electrodes via the transformer; and
the saturable core is saturated by application of the breakdown voltage and remains saturated at least through application of the follow-on current.

28. The method of inventive aspect 27, wherein each of applying the breakdown voltage and applying the follow-on current comprises closing a switching element coupled in a path from the at least two electrodes that includes the energy storage device and the transformer.

29. The method of any one of inventive aspects 16 to 28, wherein at least distal tips of the at least two electrodes are only proximate to an environment having a peak pressure below 300 pounds per square inch (PSI) while the breakdown voltage and the follow-on current are applied.

30. The method of any one of inventive aspects 16 to 28, wherein at least distal tips of the at least two electrodes are only proximate to an environment having a peak pressure below 150 pounds per square inch (PSI) while the breakdown voltage and the follow-on current are applied.

31. A plasma generation system comprising at least two electrodes and circuitry configured to perform the method of any one of inventive aspects 16 to 30.

32. A method of plasma generation, the method comprising:
applying, to at least two electrodes, a breakdown voltage sufficient to induce breakdown between the at least two electrodes, resulting in formation of plasma between the at least two electrodes; and
applying, to the at least two electrodes, after applying the breakdown voltage and before total recombination of the plasma, a follow-on current including a pulse having a rise time shorter than 10 μs.

33. The method of inventive aspect 32, wherein applying the follow-on current comprises altering a rate of current decay through the plasma with respect to current decay following breakdown without the follow-on current.

34. The method of inventive aspect 33, wherein altering the rate of current decay comprises actively applying the follow-on current to produce a higher current than would be flowing through the plasma following breakdown without applying the follow-on current.

35. The method of inventive aspect 32 or 33, wherein applying the follow-on current is before a next application of the breakdown voltage to the at least two electrodes.

36. The method of any one of inventive aspects 32 to 35, wherein the pulse is applied at a time at least two microseconds following breakdown.

37. The method of any one of inventive aspects 32 to 36, wherein the rise time is shorter than 20 μs.

38. The method of any one of inventive aspects 32 to 37, wherein applying the follow-on current comprises applying, to the at least two electrodes, at least two pulses of current comprising the pulse having the rise time applied at a time at least two microseconds following breakdown.

39. The method of inventive aspect 38, wherein the pulse has a first peak current and a second pulse of current of the at least two pulses of current has a second peak current that is different from the first peak current.

40. The method of inventive aspect 39, wherein one of the first peak current and the second peak current occurs after and is higher in current than the other of the first peak current and the second peak current.

41. The method of any one of inventive aspects 32 to 40, wherein:
applying the breakdown voltage comprises applying the breakdown voltage from an energy storage device to the at least two electrodes via a transformer having a saturable core;
applying the follow-on current comprises applying the follow-on current from the energy storage device to the at least two electrodes via the transformer; and
the saturable core is saturated by application of the breakdown voltage and remains at least partially saturated at least through application of the follow-on current.

42. The method of inventive aspect 41, wherein each of applying the breakdown voltage and applying the follow-on current comprises closing a switching element coupled in a path from the at least two electrodes that includes the energy storage device and the transformer.

43. The method of any one of inventive aspects 32 to 42, wherein applying the follow-on current through the plasma comprises propagating the plasma along a length of the at least two electrodes.

44. The method of any one of inventive aspects 32 to 43, wherein at least distal tips of the at least two electrodes are only proximate to an environment having a pressure below 300 pounds per square inch (PSI) while the breakdown voltage and the follow-on current are applied.

45. The method of any one of inventive aspects 32 to 43, wherein at least distal tips of the at least two electrodes are only proximate to an environment having a pressure below 150 pounds per square inch (PSI) while the breakdown voltage and the follow-on current are applied.

46. A plasma generation system comprising at least two electrodes and circuitry configured to perform the method of any one of inventive aspects 32 to 45.

47. A method of plasma generation, the method comprising:
applying, to at least two electrodes:
a breakdown voltage sufficient to induce breakdown between the at least two electrodes, resulting in formation of plasma between the at least two electrodes; and
after the breakdown and before total recombination of the plasma, an amount of electrical energy sufficient to directionally propagate the plasma while keeping thermal expansion of the at least two electrodes below a threshold thermal expansion amount.

48. The method of inventive aspect 47, wherein the threshold thermal expansion amount is based on a pressure gradient in which the at least two electrodes are disposed when the amount of electrical energy is applied.

49. The method of any one of inventive aspects 32 to 48, wherein the rise time is shorter than 3 μs.

50. The method of any one of inventive aspects 47 to 49, wherein applying the amount of electrical energy comprises applying, to the at least two electrodes, at least two pulses of current.

51. The method of inventive aspect 50, wherein a first pulse of current and a second pulse of current of the at least two pulses of current have peak currents that are different.

52. The method of inventive aspect 51, wherein the second pulse of current is applied after the first pulse of current and has a higher peak current than the first pulse of current.

53. The method of any one of inventive aspects 47 to 52, wherein applying the amount of electrical energy is before a next application of the breakdown voltage to the at least two electrodes.

54. The method of any one of inventive aspects 47 to 53, wherein:
applying the breakdown voltage comprises applying the breakdown voltage from an energy storage device to the at least two electrodes via a transformer having a saturable core;
applying the amount of electrical energy comprises applying the amount of electrical energy from the energy storage device to the at least two electrodes via the transformer; and
the saturable core is saturated by application of the breakdown voltage and remains saturated at least through application of the amount of electrical energy.

55. The method of inventive aspect 54, wherein each of applying the breakdown voltage and applying the amount of electrical energy comprises closing a switching element coupled in a path from the at least two electrodes that includes the energy storage device and the transformer.

56. The method of any one of inventive aspects 47 to 55, wherein at least distal tips of the at least two electrodes are only proximate to an environment having a peak pressure below 300 pounds per square inch (PSI) while the breakdown voltage and the amount of electrical energy are applied.

57. The method of any one of inventive aspects 47 to 55, wherein at least distal tips of the at least two electrodes are only proximate to an environment having a peak pressure below 150 pounds per square inch (PSI) while the breakdown voltage and the amount of electrical energy are applied.

58. A plasma generation system comprising at least two electrodes and circuitry configured to perform the method of any one of inventive aspects 47 to 57.

59. A method of plasma generation, the method comprising:
applying, to at least two electrodes, while at least distal tips of the at least two electrodes are only proximate to an environment having a pressure below 300 pounds per square inch (PSI):
a breakdown voltage sufficient to induce breakdown between the at least two electrodes, resulting in formation of plasma between the at least two electrodes; and
after the breakdown and before total recombination of the plasma, follow-on current sufficient to prevent total recombination of the plasma while controllably directionally propagating the plasma.

60. The method of inventive aspect 59, wherein the pressure is below 150 PSI.

61. The method of inventive aspect 59 or 60, wherein the follow-on current comprises a peak current exceeding 450 amperes (A).

62. The method of any one of inventive aspects 59 to 61, wherein the follow-on current comprises a pulse duration short enough to prevent material state alteration of the at least two electrodes during application of the follow-on current.

63. The method of any one of inventive aspects 59 to 62, wherein the follow-on current comprises a pulse having a rise time shorter than 5 ns.

64. The method of any one of inventive aspects 59 to 63, wherein the follow-on current comprises a current rate-of-change with an absolute value exceeding 90 A/μs.

65. The method of any one of inventive aspects 59 to 64, wherein the follow-on current comprises an amount of electrical energy that is sufficient to controllably directionally propagate the plasma while keeping thermal expansion of the at least two electrodes below a threshold thermal expansion amount.

66. The method of any one of inventive aspects 59 to 65, wherein applying the follow-on current comprises altering a rate of current decay through the plasma with respect to current decay following breakdown without the follow-on current.

67. The method of inventive aspect 66, wherein altering the rate of current decay comprises actively applying the follow-on current to produce a higher current than would be flowing through the plasma following breakdown without applying the follow-on current.

68. The method of any one of inventive aspects 59 to 67, wherein applying the follow-on current is before a next application of the breakdown voltage to the at least two electrodes.

69. The method of any one of inventive aspects 59 to 68, wherein applying the follow-on current comprises applying, to the at least two electrodes, at least two pulses of current comprising a first pulse applied at a time at least two microseconds following breakdown.

70. The method of inventive aspect 69, wherein the first pulse has a first peak current and a second pulse of current of the at least two pulses of current has a second peak current that is different from the first peak current.

71. The method of inventive aspect 70, wherein one of the first peak current and the second peak current occurs after and is higher in current than the other of the first peak current and the second peak current.

72. The method of any one of inventive aspects 59 to 71, wherein:
applying the breakdown voltage comprises applying the breakdown voltage from an energy storage device to the at least two electrodes via a transformer having a saturable core;
applying the follow-on current comprises applying the follow-on current from the energy storage device to the at least two electrodes via the transformer; and
the saturable core is saturated by application of the breakdown voltage and remains at least partially saturated at least through application of the follow-on current.

73. The method of inventive aspect 72 wherein each of applying the breakdown voltage and applying the follow-on current comprises closing a switching element coupled in a path from the at least two electrodes that includes the energy storage device and the transformer.

74. The method of any one of inventive aspects 59 to 73, wherein applying the follow-on current through the plasma comprises propagating the plasma along a length of the at least two electrodes.

75. A plasma generation system comprising at least two electrodes and circuitry configured to perform the method of any one of inventive aspects 59 to 74.

76. A method of ignition, the method comprising:
applying, to a plurality of electrodes, a breakdown voltage sufficient to induce breakdown between the plurality of electrodes, resulting in formation of plasma between the plurality of electrodes; and
applying, to the plurality of electrodes, after applying the breakdown voltage and before total recombination of the plasma, a pulse of current having a peak current greater than 450 amperes (A),
wherein the peak current is at a time at which current flowing between the plurality of electrodes would be lower than the peak current without application of the pulse of current.

77. The method of inventive aspect 76, wherein applying the pulse of current is before a next application of the breakdown voltage to the plurality of electrodes.

78. The method of inventive aspect 76 or 77, wherein the peak current exceeds 550 A at the time.

79. The method of inventive aspect 76 or 77, wherein the peak current exceeds 600 A at the time.

80. The method of any one of inventive aspects 76 to 79, further comprising applying, to the plurality of electrodes, after applying the breakdown voltage and the pulse of current, and before total recombination of the plasma, a second pulse of current.

81. The method of inventive aspect 80, wherein a second pulse of current has a second peak current that is different from the peak current.

82. The method of inventive aspect 81, wherein the second peak current is higher in current than the second peak current.

83. The method of any one of inventive aspects 76 to 82, wherein:
applying the breakdown voltage comprises applying the breakdown voltage from an energy storage device to the plurality of electrodes via a transformer having a core;
applying the pulse of current comprises applying the pulse of current from the energy storage device to the plurality of electrodes via the transformer; and
the core is saturated by application of the breakdown voltage and remains saturated at least through application of the follow-on current.

84. The method of inventive aspect 83, wherein each of applying the breakdown voltage and applying the follow-on current comprises closing a switching element coupled in a path from the plurality of electrodes that includes the energy storage device and the transformer.

85. The method of any one of inventive aspects 76 to 84, wherein applying the pulse of current comprises propagating the plasma along a length of the plurality of electrodes.

86. The method of any one of inventive aspects 76 to 85, wherein at least a portion of the plurality of electrodes is only proximate to an environment having a pressure below 300 pounds per square inch (PSI) while the breakdown voltage and the follow-on current are applied.

87. The method of any one of inventive aspects 76 to 85, wherein at least a portion of the plurality of electrodes is only proximate to an environment having a peak pressure below 150 pounds per square inch (PSI while the breakdown voltage and the pulse of current are applied.

88. An ignition system comprising a plurality of electrodes and circuitry configured to perform the method of any one of inventive aspects 76 to 87.

89. A method of plasma generation, the method comprising:
applying, to at least two electrodes, a breakdown voltage sufficient to induce breakdown between the at least two electrodes, resulting in formation of plasma between the at least two electrodes; and
applying, to the at least two electrodes, after the breakdown and before total recombination of the plasma, follow-on current sufficient to prevent total recombination of the plasma while controllably directionally propagating the plasma,
wherein the breakdown voltage and the follow-on current collectively comprise an amount of energy exceeding one-third of a Joule (J).

90. The method of inventive aspect 89, wherein the amount of energy exceeds 2 J.

91. The method of inventive aspect 89, wherein the amount of energy exceeds 4 J.

92. The method of inventive aspect 89, wherein the amount of energy exceeds 10 J.

93. The method of any one of inventive aspects 89 to 92, wherein the follow-on current comprises a peak current exceeding 450 amperes (A).

94. The method of any one of inventive aspects 89 to 93, wherein the follow-on current comprises a pulse duration short enough to prevent material state alteration of the at least two electrodes during application of the follow-on current.

95. The method of any one of inventive aspects 89 to 94, wherein the follow-on current comprises a pulse having a rise time shorter than 10 μs.

96. The method of any one of inventive aspects 89 to 95, wherein the follow-on current comprises a current rate-of-change with an absolute value exceeding 90 A/μs.

97. The method of any one of inventive aspects 89 to 96, wherein the follow-on current comprises an amount of electrical energy that is sufficient to controllably directionally propagate the plasma while keeping thermal expansion of the at least two electrodes below a threshold thermal expansion amount.

98. The method of any one of inventive aspects 89 to 96, wherein applying the follow-on current comprises altering a rate of current decay through the plasma with respect to current decay following breakdown without the follow-on current.

99. The method of inventive aspect 98, wherein altering the rate of current decay comprises actively applying the follow-on current to produce a higher current than would be flowing through the plasma following breakdown without applying the follow-on current.

100. The method of any one of inventive aspects 89 to 98, wherein applying the follow-on current is before a next application of the breakdown voltage to the at least two electrodes.

101. The method of any one of inventive aspects 89 to 100, wherein applying the follow-on current comprises applying, to the at least two electrodes, at least two pulses of current comprising a first pulse applied at a time at least two microseconds following breakdown.

102. The method of inventive aspect 101, wherein the first pulse has a first peak current and a second pulse of current of the at least two pulses of current has a second peak current that is different from the first peak current.

103. The method of inventive aspect 102, wherein one of the first peak current and the second peak current occurs after and is higher in current than the other of the first peak current and the second peak current.

104. The method of any one of inventive aspects 89 to 103, wherein:
applying the breakdown voltage comprises applying the breakdown voltage from an energy storage device to the at least two electrodes via a transformer having a saturable core;
applying the follow-on current comprises applying the follow-on current from the energy storage device to the at least two electrodes via the transformer; and
the saturable core is saturated by application of the breakdown voltage and remains at least partially saturated at least through application of the follow-on current.

105. The method of inventive aspect 104 wherein each of applying the breakdown voltage and applying the follow-on current comprises closing a switching element coupled in a path from the at least two electrodes that includes the energy storage device and the transformer.

106. The method of any one of inventive aspects 89 to 105, wherein applying the follow-on current through the plasma comprises propagating the plasma along a length of the at least two electrodes.

107. A plasma generation system comprising at least two electrodes and circuitry configured to perform the method of any one of inventive aspects 89 to 106.

108. The plasma generation system of inventive aspect 107, wherein the circuitry comprises an energy storage device and a switching element configured to apply the breakdown voltage and/or the follow-on current to the at least two electrodes from the energy storage device.

1. A method of plasma generation, the method comprising:
applying, to at least two electrodes, a breakdown voltage sufficient to induce breakdown between the at least two electrodes, resulting in formation of plasma in an initiation region between the at least two electrodes; and
applying, to the at least two electrodes, after applying the breakdown voltage and before total recombination of the plasma, a follow-on current through the plasma, the follow-on current having a peak current that exceeds 450 amperes (A) at a time at least two microseconds following breakdown.

2. The method of claim 1, wherein applying the follow-on current comprises altering a rate of current decay through the plasma with respect to current decay following breakdown without the follow-on current.

3. The method of claim 2, wherein altering the rate of current decay comprises actively applying the follow-on current to produce a higher current than would be flowing through the plasma following breakdown without applying the follow-on current.

4. The method of claim 1, wherein applying the follow-on current is before a next application of the breakdown voltage to the at least two electrodes.

5. The method of claim 1, wherein the peak current exceeds 550 A at the time at least two microseconds following breakdown.

6. The method of claim 1, wherein the peak current exceeds 600 A at the time at least two microseconds following breakdown.

7. The method of claim 1, wherein applying the follow-on current comprises applying, to the at least two electrodes, at least two pulses of current having at least the peak current, wherein a first pulse of current of the at least two pulses of current has the peak current at the at least two microseconds following breakdown.

8. The method of claim 7, wherein the peak current is a first peak current and wherein a second pulse of current of the at least two pulses of current has a second peak current that is different from the first peak current.

9. The method of claim 8, wherein one of the first peak current and the second peak current occurs after and is higher in current than the other of the first peak current and the second peak current.

10. The method of claim 1, wherein:
applying the breakdown voltage comprises applying the breakdown voltage from an energy storage device to the at least two electrodes via a transformer having a saturable core;
applying the follow-on current comprises applying the follow-on current from the energy storage device to the at least two electrodes via the transformer; and
the saturable core is saturated by application of the breakdown voltage and remains at least partially saturated at least through application of the follow-on current.

11. The method of claim 10, wherein each of applying the breakdown voltage and applying the follow-on current comprises closing a switching element coupled in a path from the at least two electrodes that includes the energy storage device and the transformer.

12. The method of claim 1, wherein applying the follow-on current through the plasma comprises propagating the plasma along a length of the at least two electrodes.

13. The method of claim 1, wherein at least distal tips of the at least two electrodes are only proximate to an environment having a pressure below 300 pounds per square inch (PSI) while the breakdown voltage and the follow-on current are applied.

14. The method of claim 1, wherein distal tips of the at least two electrodes are proximate to an environment having a pressure below 150 pounds per square inch (PSI) while the breakdown voltage and the follow-on current are applied.

15. A plasma generation system comprising at least two electrodes and circuitry configured to perform the method of claim 1.
